(19) United States
(12) Patent Application Publication
(10) Pub. No.: US 2007/0237996 A1
(43) Pub. Date: Oct. 11, 2007

(54) Fuel cell system

(75) Inventors: Christof Kindervater, Stuttgart (DE); Andreas Brinner, Rutesheim (DE); Martin Nedele, Reutlingen (DE)

Correspondence Address: Lipsitz & McAllister, LLC, 755 MAIN STREET, MONROE, CT, 06468, US

(73) Assignee: Deutsches Zentrum fuer Luft-und Raumfahrt e.V., Koeln (DE)

(21) Appl. No.: 11/724,594

(22) Filed: Mar. 14, 2007

Related U.S. Application Data
(63) Continuation of application No. PCT/EP05/09557, filed on Sep. 6, 2005.

(30) Foreign Application Priority Data
Sep. 17, 2004 (DE) 10 2004 046 004.3
Dec. 7, 2004 (DE) 10 2004 059 776.6

(51) Int. Cl. H01M 8/04; H01M 8/06

(52) U.S. Cl. 429/22; 429/34; 429/19

(57) ABSTRACT

To provide a fuel cell system, comprising a fuel cell device having one or more fuel cell blocks in which chemical energy can be converted into electrical energy, an oxidant supply device for the fuel cell device, a fuel supply device for the fuel cell device, and a control device, which can be used in a versatile manner, it is provided that the fuel cell device and/or the oxidant supply device and/or the fuel supply device is/are formed as a module, the functional components of the respective device being disposed in a module, the respective module forming a unit which can be put in place as a whole, and the respective module having a communication interface which has connectors.

This application is a continuation of international application number PCT/EP2005/009557 filed on Sep. 6, 2005.

The present disclosure relates to the subject matter disclosed in international application number PCT/EP2005/009557 of Sep. 6, 2005 and German applications number 10 2004 046 004.3 of Sep. 17, 2004, and number 10 2004 059 776.6 of Dec. 7, 2004, which are incorporated herein by reference in their entirety and for all purposes.

### BACKGROUND OF THE INVENTION

The invention relates to a fuel cell system, comprising a fuel cell device having one or more fuel cell blocks in which chemical energy can be converted into electrical energy, an oxidant supply device for the fuel cell device, a fuel supply device for the fuel cell device, and a control device.

The invention further relates to a fuel cell device for a fuel cell system having one or more fuel cell blocks in which chemical energy can be converted into electrical energy.

In addition, the invention relates to an oxidant supply device for a fuel cell device of a fuel cell system.

In addition, the invention relates to a fuel supply device for a fuel cell device of a fuel cell system.

Fuel cell systems comprising a fuel cell device having one or more fuel cell blocks in which chemical energy can be converted into electrical energy, an oxidant supply device for the fuel cell device, a fuel supply device for the fuel cell device, and a control device, are known for example from DE 101 27 600 A1 and C2 or from DE 101 27 599 A1.

### SUMMARY OF THE INVENTION

In accordance with the present invention, a fuel cell system is provided, which can be used in a versatile manner.

In accordance with an embodiment of the invention, in the fuel cell system the fuel cell device and/or the oxidant supply device and/or the fuel supply device is/are formed as a module, the functional components of the respective device being disposed in a module, the respective module forming a unit which can be put in place as a whole, and the respective module having a communication interface which has connectors.

By virtue of the solution according to the invention, modules may be produced, set up and put in place separately. By virtue of the modular construction of the fuel cell system, the system may be integrated in a versatile manner into an implementation using the system. In particular, adaptation to geometrical features is possible.

For each module, a defined interface is provided for communication with the outside world and other modules in respect of exchange of substances (by way of flows of substances) and/or exchange of energy and/or exchange of signals.

This enables the fuel cell system to be assembled from subsystems, the subsystems being separately adjustable, in particular with regard to the respective parameters of operation. In particular, the operating parameters in respect of flows of substances, electrical currents and signal currents may, for each module, be separately set and also optimised.

The result is that the fuel cell system is capable of being easily dismantled and assembled.

Furthermore, components relevant to safety may be formed separately. For conveying the fuel, only the fuel supply device module and fuel cell device module then remain relevant. The other modules are then no longer relevant from the point of view of safety.

The methods described in DE 101 27 599 A1 and DE 101 27 600 A1 and DE 101 27 600 C2 may be carried out with the fuel cell system according to the invention. In addition, the fuel cell system according to the invention may be formed as described in these specifications. Specific reference is made to these specifications.

It is advantageous in particular, if a respective module has a housing in which the functional components are located. By way of the housing, the module may be formed as a unit. Furthermore, a defined interface and in particular a defined communication interface may be located on the housing. The functional components are protected in the housing. For example, the housing is produced at least in part from a transparent material, so that measuring equipment such as pressure gauges may be read.

In particular, the connector(s) are located on the housing, by means of which connector(s) modules can communicate between one another or with suitable devices.

It may be provided that the housing is closed. In this way, the functional components which are located in the housing, are protected.

It is especially advantageous if the housing is gastight, in particular in the case of the fuel cell device module and the fuel supply device module. In this way, escape of fuel at undefined points may be avoided. The system may be provided with a safety venting arrangement, directly into the surrounding region.

The connectors comprise in particular connectors for substances, signal connectors and electrical power connectors. Exchange of substances can be effected by way of the substance connectors. For example, fuel may be withdrawn by way of a draw-off connector of the fuel supply device module, and fuel may be fed into the fuel cell device by way of a fuel infeed connector on the fuel cell device. Control signals can be fed in by way of signal connectors or control signals may be picked up. Electrical power can be fed in by way of electrical power connectors or (in the case of the fuel cell device) can be drawn off.

In particular, the fuel cell device module has connectors for substances for oxidant and fuel and a connector for drawing off electrical power.

It may also be provided that the fuel cell device module has at least one signal connector for feeding in control signals. Control signals may for example be fed in by way of such a connector in order to open and close a stop valve in a timed sequence, by way of which unused fuel can be discharged.

It is further provided that the fuel supply device module has at least one fuel connector for drawing off fuel. A connection to the fuel cell device can be produced by way of this fuel connection.

It can also be provided that the fuel supply device module has at least one signal connector.

It is further provided that the oxidant supply device module has at least one oxidant connector for drawing off oxidant. In this way, air with atmospheric oxygen as oxidant may be drawn off. The connection to a fuel cell device is produced by way of this connector.

It can also be provided that the oxidant supply device module has at least one signal connector, by way of which in particular control signals can be fed in.

It is most especially advantageous if the communicating modules are connected by way of lines or conduits. The modules may be positioned on an implementation using the system, initially separately and independently of one another. The required communication connections in respect of substance transport, supply of electrical power and relating to control signals are effected afterwards in accordance with the geometrical features. There results in this way, a versatile construction, the fuel cell system according to the invention being formed by way of subsystems.

In particular, the lines and conduits are elements which are separate from the module(s).

It can be provided that one or more fuel storage units are integrated into the fuel supply module. When a fuel storage unit has been emptied, then for example the fuel supply device module as a whole may be exchanged. It may also be provided that at least one fuel storage unit is provided which is coupled to the fuel supply device and in particular forms an external element relative to a fuel supply device module.

One or more fuel storage modules may also be provided. A fuel storage module may be coupled to a fuel supply device module. When a fuel storage unit has been emptied, a respective fuel storage module can be exchanged in easy manner.

It is most especially advantageous if the at least one fuel storage unit or the at least one fuel storage module is formed as a structural element of the fuel cell system or of an implementation using the system. In this way, the energy supply device of the implementation using the system, which is formed with the help of the fuel cell system, may be configured in a space-saving manner.

In particular, the at least one fuel storage unit or the at least one fuel storage module is a metal hydride storage unit or comprises such a unit. Hydrogen is not stored in a metal hydride storage unit as free gas but rather in bound-in form. For example, hydrogen may be driven out of a metal hydride storage unit of this kind by heating it up. The safety problems do not then occur which would be present in the case of hydrogen storage in a pressurised tank. A metal hydride storage unit is a solid element, which equates to a structural element and can for example be used as a load-bearing element for an implementation using the system.

In particular, the at least one fuel storage unit is formed by means of one or more extrusion profiles. Suitable metal hydride storage units are for example obtainable under the designation MH Hydrogene Storage Tank from SUMITOMO PRECISION PRODUCTS CO., LTD., Japan.

Advantageously, a cooling device is associated with the fuel cell device. In this way, the cooling device allows operation at optimum efficiency.

It is quite especially advantageous for the cooling device to be so located and formed that at least one fuel storage unit can be impinged on by air conveying waste heat. The air conveying waste heat can then be used for example for driving the hydrogen out of a metal hydride storage unit. In this way, the efficiency of the fuel cell system may be improved.

It is in principle possible for the cooling device to be integrated with the fuel cell device in a fuel cell device module. It is also possible for the cooling device to be formed as a module.

In particular, the cooling device module has at least one connector for air conveying waste heat. Waste heat may be drawn off at this connector, in order for example to be delivered to a metal hydride storage unit.

It is advantageous if the cooling device module has at least one signal connector. For example, the respective cooling device can then be so controlled by way of control signals that an optimal cooling effect results.

It can also be provided that the control device is formed as a module. The control device forms then an individual component of the fuel cell system. In particular, a central control device is realised.

Advantageously control of the procedure is provided by the control device, which sends preset control signals. No regulation of the fuel feed and oxidant feed to the fuel cell device is effected, but at the most control. A suitable method is described in DE 101 27 600 A1, specific reference being made to this document.

It is advantageous if electricity-consuming features of the fuel cell system are supplied with electrical energy by way of the control device. The control device provides then a defined interface, by way of which the respective module can receive the electrical energy in the required form.

It is advantageous if, for each module, the operating parameters in respect of flows of substances, electric currents and signal currents are independently adjustable and/or set. In this way, there results an optimised adaptability of the fuel cell system to implementations using the system along with ease of manufacturability. Each module may thereby be optimised separately.

It is especially advantageous if, in the fuel supply device module and/or the oxidant supply module and/or the fuel cell device module, substance guidance is provided by means of a bore, this bore being produced in particular by a cut-out in a solid material. In this way, a kind of substance transport bus may be provided within a module of this kind. No guidance requiring a tube needs to be provided. In particular, when fuel is conveyed, the danger of leaks is greatly reduced by this arrangement. A module has for example a block-shaped plastics housing. In a block-shaped plastics housing of this kind, substance guidance may be defined by way of a bore.

It is most especially advantageous if the pressure and the volume flow of the air which can be drawn off as oxidant carrier is set to a constant value for the oxidant supply device. In this way, an easily operable fuel cell system is formed, as is described in DE 101 27 600 A1 and DE 101 27 600 C2.

For the same reason, it is advantageous if the pressure of fuel which can be drawn off is set to a constant value for the fuel supply device.

In particular, the pressure difference for fuel which can be drawn off in relation to the air which can be drawn off as oxidant carrier from the oxidant supply device is set to a constant value for the fuel supply device. A suitable method of control is described in DE 101 27 600 A1, to which reference is specifically made,

It is especially advantageous if regulation of the quantity of the fuel supplied to the fuel cell device is effected by the electrical power take-up by a consumer. In this way, there results simple control and regulation of the fuel cell system, since the consumer “automatically” regulates the feed of fuel.

In accordance with the invention, a fuel cell device for a fuel cell system having one or more fuel cell blocks in which chemical energy can be converted into electrical energy is provided, which can be handled in an easy manner.

In accordance with an embodiment of the invention, a fuel cell device is formed as a module, the functional components of the fuel cell device being disposed in the module, the module forming a unit which can be put in place as a whole, and the module having a communication interface with connectors.

The advantages of this solution have already been described above in connection with the fuel cell system according to the invention.

Further advantageous embodiments have likewise been already explained in connection with the fuel cell system according to the invention.

In accordance with the invention, an oxidant supply device is provided, which can be handled in an easy manner.

In accordance with an embodiment of the invention, the oxidant supply device is formed as a module, the functional components of the oxidant supply device being disposed in the module, the module forming a unit which can be put in place as a whole, and the respective module having a communication interface with connectors.

The solution according to the invention has already been described above in connection with the fuel cell system according to the invention.

Further advantageous embodiments have likewise been already explained in connection with the fuel cell system according to the invention.

In accordance with the invention, a fuel supply device is provided, which can be handled in an easy manner.

In accordance with an embodiment of the invention, the fuel supply device is formed as a module, the functional components of the fuel supply device being disposed in the module, the module forming a unit which can be put in place as a whole, and the module having a communication interface with connectors.

The solution according to the invention has the advantages already explained in connection with the fuel cell system according to the invention.

Further advantageous configurations have already been explained in connection with the fuel cell system according to the invention.

The following description of preferred embodiments serves for more detailed explanation of the invention in conjunction with the drawings.

### BRIEF DESCRIPTION OF THE DRAWINGS

FIG. 1 shows a schematic representation of an embodiment of a fuel cell system in accordance with the invention depicted in a modular construction;

FIG. 2 shows an embodiment of an oxidant supply device module;

FIG. 3 shows an embodiment of a fuel cell device module;

FIG. 4 shows an embodiment of a fuel supply device module and

FIG. 5 shows an embodiment of a fuel storage module.

### DETAILED DESCRIPTION OF THE INVENTION

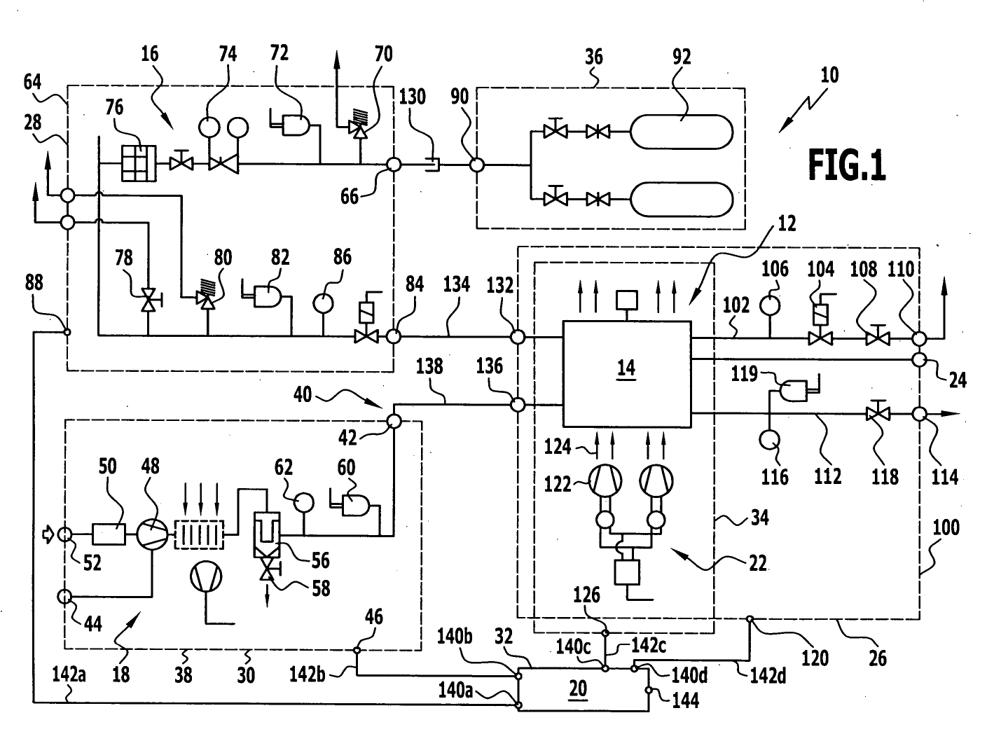

An embodiment of a fuel cell system in accordance with the invention, which is shown in FIG. 1 and is designated there as 10, comprises a fuel cell device 12 having one or more fuel cell blocks 14. The fuel cell device 12 is the fuel cell core device of the fuel cell system 10. In addition, the fuel cell system 10 comprises a fuel supply device 16, by mans of which the fuel cell block(s) 14 of the fuel cell device 12 can be supplied with fuel.

Furthermore, the fuel cell system 10 comprises an oxidant supply device 18 for the fuel cell device 12, by means of which oxidant can be supplied to the fuel cell block(s) 14.

A control device 20 is provided for control of the fuel cell system 10.

A cooling device 22 may be associated with the fuel cell block(s) 14.

For the fuel cells of the fuel cell block(s) 14, there is in question in particular polymer-exchange fuel cells (PEFC), in which the electrolyte is formed by a proton-conducting membrane. In addition to its role in respect of the electrolyte, the membrane is also catalyst carrier for the electrocatalysts and serves as separator for the gaseous reactants. Hydrogen is used as fuel, and oxygen, in particular atmospheric oxygen, is used as oxidant. Air with atmospheric oxygen as oxidant is then supplied to the fuel cell device 12.

In the fuel cell block(s) 14, chemical energy is converted into electrical energy by the cold combustion of the fuel with the oxidant. This electrical energy can be delivered to a consumer by way of a connector 24.

The fuel cell system 10 is constructed in modular form, having a fuel cell device module 26, a fuel supply device module 28 and an oxidant supply device module 30.

In addition, a control device module 32 is provided, which comprises the control device 20.

The cooling device 22 is integrated into a cooling device module 34.

A fuel storage module 36 is provided in the embodiment illustrated. Alternatively, it is also possible for fuel storage to be integrated into the fuel supply device module 28.

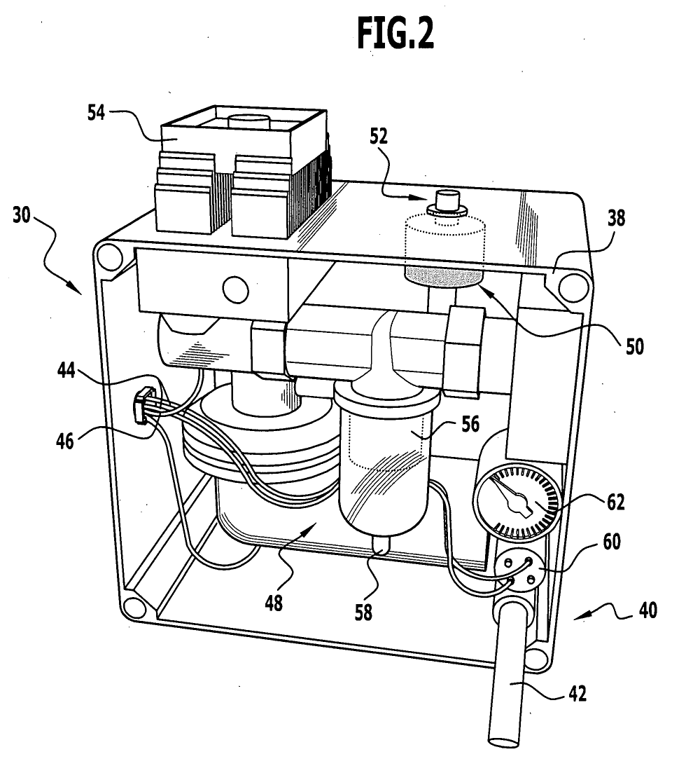

The functional components of the oxidant supply device 18 are integrated into the oxidant supply device module 30 (FIGS. 1 and 2). The oxidant supply device module 30 has a closed housing 38. The housing can be configured to be gastight. For example, the housing is transparent. A possible material is Perspex.

The oxidant supply device module 30 is provided with a communication interface 40, which has an outlet connector 42 by way of which the oxidant can be drawn off. In particular, air as oxidant carrier can be drawn off with atmospheric oxygen as oxidant.

In addition, an electrical connector 44 is provided, by way of which electrical energy can be fed into the oxidant supply device module 30 for supply to an electricity-consuming feature of this module.

Furthermore, a signal connector 46 can be provided for feeding in control signals.

Suitable connectors 42, 44 and 46 are provided on the housing 38.

An air compressor 48 is located in the housing 38. A filter 50 is disposed upstream of the compressor. The housing 38 has one or more air supply openings 52, by way of which the air can be supplied to the air compressor 48, the air supplied having to pass through the filter 50. An air conveyor and cooler 54 is disposed at the air supply opening(s) and is in particular driven by way of an electric motor.

A water separator 56 is disposed in the housing 38 downstream of the air compressor 48. Air passing through the oxidant supply device module 30 may be demoisturised by way of this water separator 56. A control element 58 is then associated with the water separator 56, this element connecting with an outlet by way of which the water may be discharged.

The oxidant supply device module 30 also comprises a pressure switch 60 and a pressure gauge 62. A specific airflow from the air compressor 48 may be controlled by means of the pressure switch 60. This airflow is set to a constant value by a control device (such as for example the regulating valve 118). The airflow may be drawn off at the outlet connector 42.

For controlling the supply device module 30, a controlling device may also be connected directly to the module 30 and/or connected only temporarily.

The oxidant supply device module 38 forms a unit which can be put in place as a whole. The connection to the control device module 32 is effected by way of the communication interface 40. The connection to the fuel cell device module 26 is effected by way of the connector 42 (as an interface for the flow of substances). Electricity-consuming features of the oxidant supply device module 30 are supplied with electrical energy (which is fed in at the electrical connector 44) by way of the control device module 32.

The fuel supply device module 28 has a housing 64, in which the functional components of the fuel supply device 16 are disposed. The housing 64 is in particular formed to be closed and gastight. It is preferably provided that passageways for fuel are formed within the fuel supply device module 28, without tubing. For example, the housing 64 is formed by means of a Perspex block and the respective flow passages (conduits) are formed by bores in the Perspex block. In this way, a kind of bus system for flow guidance of the fuel within the fuel supply device module 28 is provided.

In the embodiment shown in FIG. 1, fuel storage is located outside the fuel supply device module 28. For this, a specific fuel storage module 36 is provided. In order to be able to feed in fuel which is delivered from the fuel storage module 36, a connector 66 is provided on the housing 64 for feeding in fuel. This connector 66 is in fluid-operative connection with a fuel passage 68 within the housing 64. A safety valve 70 is connected to this fuel passage 68. Furthermore, a pressure switch 72 is provided, by way of which the pressure of the fuel (in particular hydrogen) conveyed within the housing 64 can be controlled. A pressure reducing/regulating device 74 with a pressure gauge is connected downstream of the pressure switch 72. In addition, a flame barrier 76 is provided.

Following on the flame barrier 76, a discharge valve 78 is disposed in the fuel passage 68. Gaseous fuel in the housing 64 may be taken off by way of the discharge valve 78.

Furthermore an additional safety valve 80 is provided. The pressure of the fuel which can be drawn off at a connector 84 may be controlled by way of a further pressure switch 82. This pressure can be shown by way of a pressure gauge 86.

The fuel supply device module 28 has a communication interface which comprises the connectors 66 and 84. In addition, a control signal connector 88 can be provided. An electrical connection can be provided (not shown in FIG. 1) for feeding in electrical energy for supply to electricity-consuming features of the fuel supply device module 28.

The fuel supply device module 28 forms a unit which can be put in place as a whole.

The fuel storage module 36 has an interface 90 by way of which the fuel can be drawn off and in particular can be supplied to the fuel supply device module 28. The fuel storage module 36 has one or more fuel storage units 92, in which for example hydrogen is stored in gaseous form.

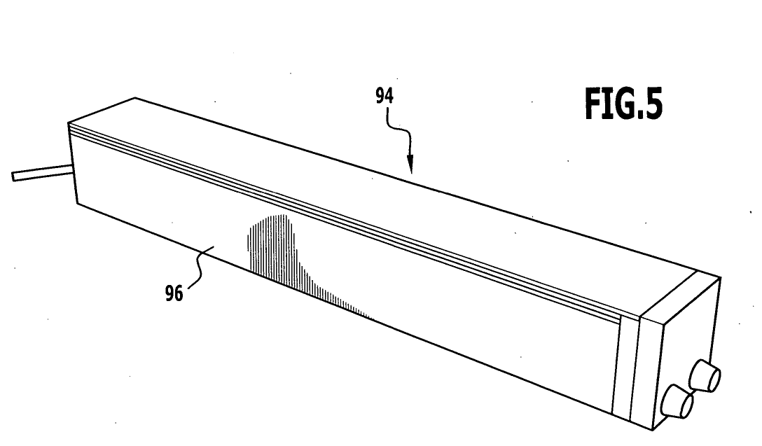

One or more metal hydride storage units 94 (FIG. 5) can be provided. A metal hydride storage unit 94 of this kind is in particular formed by means of an extrusion profile 96.

A metal hydride storage unit 94 of this kind can be a structural element of the fuel cell system 10 or of an implementation using the system. Since the extrusion profile 96 of the metal hydride storage unit 94 can be loaded mechanically, it can also take on a load-bearing function, for example in a vehicle, in order to support vehicle parts or to mount the modules of the fuel cell system 10 or to hold individual modules of the fuel cell system 10.

The fuel storage module 36 is in particular so disposed and formed that it is interchangeable. When it is empty, it can be removed and a new fuel storage module 36 can be inserted, having a filled fuel storage unit 92 or filled fuel storage units 92.

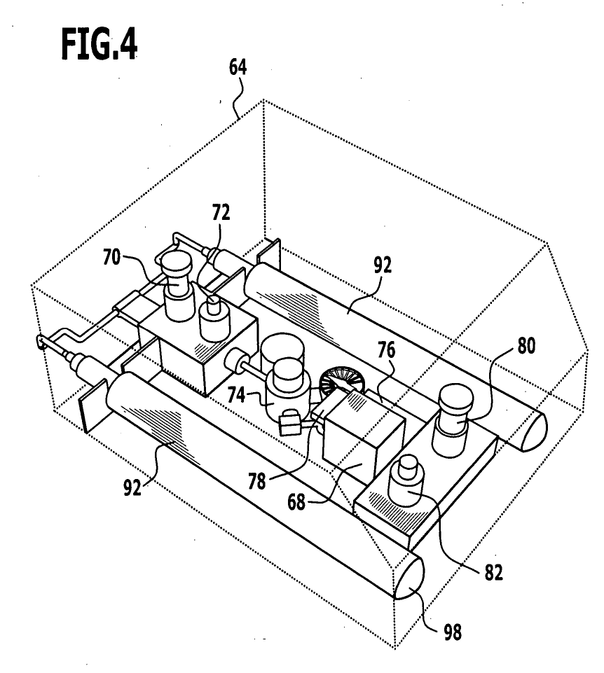

It is also possible, as shown schematically in FIG. 4, for fuel storage units 98 to be integrated into the housing 64 of the fuel supply device module 28. It is not then necessary to provide a separate fuel storage module 36, but a combination module is formed which comprises the fuel supply device 16 and the fuel storage unit(s). A fuel supply device module of the kind has in principle the same functional components as described with reference to the fuel supply device module 28. The same reference signs are therefore used in FIG. 4.

It is in particular provided that the fuel which can be drawn off at the connector 84 is set to a constant pressure value determined by way of the pressure switch. This pressure value is indicated by way of the pressure gauge 86.

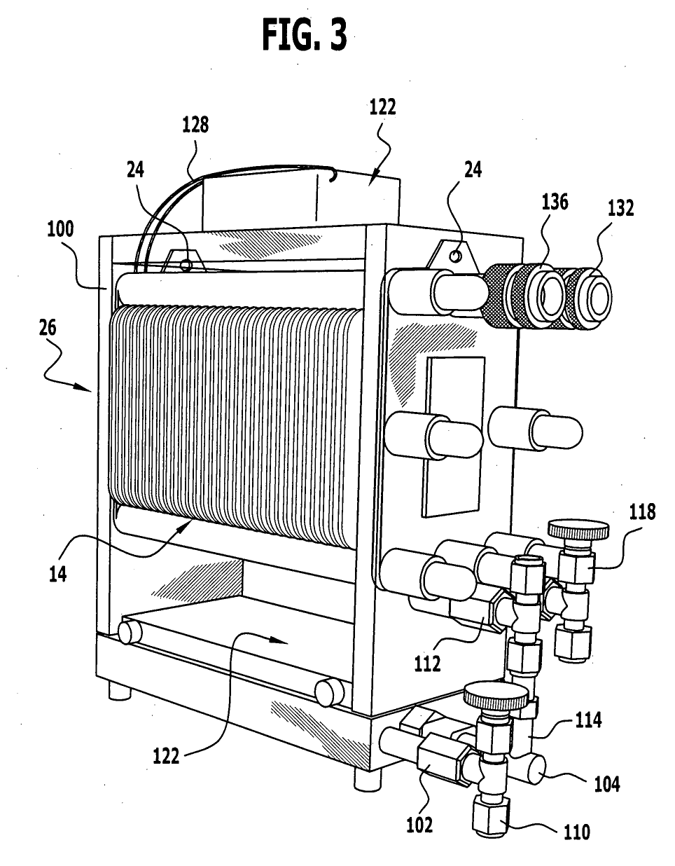

The fuel cell device module 26 has a housing 100 (FIGS. 1 and 3). The housing is in particular formed to be closed with defined cooling air guidance. For example, it is transparent.

The fuel cell block(s) 14 are located in the housing 100. In addition, a fuel exhaust conduit 102 is located in the housing 100. There is a time-controllable (stop) valve 104 on this exhaust conduit 102. For this, there is in question in particular an electro-magnetic valve. The pressure in indicated by way of a pressure gauge 106.

Furthermore, an adjustable valve 108 is provided by which the pressure drop when the valve 104 is open can be set.

The exhaust conduit 102 opens out into an outlet connector 110, by way of which unused fuel can be discharged.

Also located in the housing 100 is an oxidant exhaust conduit 112, which is in particular an air exhaust conduit. This opens out into an outlet connector 114. A pressure gauge 116 is connected to the exhaust conduit 112. In addition, an adjustable valve 118 is provided, in order to be able to set the volume flow of the exhaust air.

A temperature switch 119 can be provided on the exhaust conduit 112.

The fuel cell device module 26 has a control signal connector 120, by way of which control signals can be fed in. In particular, the valve 104 (which is a stop valve) can be controlled in this way. This stop valve 104 is controlled so that it is either open or closed. It can be controlled on a time cycle and can then be opened on a time cycle so that release of fuel from the fuel cell block 14 is taken care of.

The connector 24 by way of which external electricity-consuming features are supplied with electrical power, is disposed on the housing 100.

Electrical connections may also be provided (not shown in FIG. 1), by way of which the electrical power for internal electricity-consuming features of the fuel cell device module 26 can be fed in.

The communication interface for the fuel cell device module 26 is formed by way of the connectors described.

The fuel cell device module 26 forms a unit which can be put in place as a whole separately from the other modules.

A cooling device can also be integrated into the fuel cell device module 26.

A separate cooling device module 34 can also be provided, which can be coupled to the fuel cell device module 26.

For example, a cooling device module 34 comprises one or more fans 122, by way of which the fuel cell block(s) 14 can be acted on by an air flow 124 for cooling. The cooling device module 34 has an electrical connector by way of which energy appropriate for drive of the fan(s) 122 can be supplied (not shown in the drawing). In addition, a control signal connector 126 can be provided.

It is advantageous for the cooling device module 34 to have one or more connectors 128 for discharge of air conveying waste heat. For example, the air conveying waste heat can be conducted by way of suitable connecting conduits to a metal hydride storage unit 94 in order to activate this for release of hydrogen.

In the case of the solution in accordance with the invention, the fuel cell device module 26, the fuel supply device module 28, the oxidant supply module 30 and the control device module 32 are separate and can be put in place independently of one another. Communication between them is effected by way of the respective interfaces:

For direct coupling of the fuel storage module 36, a coupling 130 is for example provided, and in particular a quick-release coupling. A fuel conduit is then formed by way of this coupling.

It is also possible for a connection to be effected by way of a conduit which is coupled onto the connector 66 of the fuel supply device module 28 and is coupled on at the interface 90 of the fuel storage module 36.

The fuel supply device module 28 communicates with the fuel cell device module 26 by way of its fuel outlet connector 84. Fuel can be fed in at an inlet connector 132 of the fuel cell device module 26. A conduit 134 is provided for conducting the fuel between the fuel supply device module 28 and the fuel cell device module 26, which conduit is an element separate from the two modules. The conduit is selected according to the position and spacing of the two modules.

Air with atmospheric oxygen as oxidant may be drawn off at the outlet connector 42 of the oxidant supply device module 30. The fuel cell device module 26 has an inlet connector 136 by way of which the air can be fed in. The connectors 42 and 136 may be connected by way of a conduit 138, this conduit 138 being an element separate from the oxidant supply module 30 and the fuel cell device module 26.

The control device module 32 likewise forms a unit which can be put in place as a whole independently of the other modules. It has respective connectors 140a, 140b, 140c, 140d, by way of which the control signals can be taken off to modules to which control signals can be applied. Control signal lines 142a etc. may be coupled to the connectors in order to be able to transfer the control signals.

In addition, the control device module 32 has one or more connectors 144 for electrical energy. Electrical energy can be drawn off from these and fed to corresponding energy connectors on the modules by way of respective lines. In this way electricity-consuming features of the respective modules may be supplied with energy.

The fuel cell system 10 functions such that supply parameters for fuel (by way of the fuel supply device module 28) and oxidant (by way of the oxidant supply device module 30) are fixedly prescribed, the supply-side pressure of the fuel delivered to one of the fuel cell blocks 14 being prescribed, continuous discharge of hydrogen from a fuel cell block 14 being blocked and the quantity of the fuel delivered to a fuel cell block 14 being regulated by the power take-up of an (external) consumer.

Such a method is described in DE 100 27 600 A1 and DE 100 27 600 C2, as well as in DE 101 27 599 A1, along with further details of the method and the detailed construction of the corresponding fuel cell system. Reference is made to these documents.

In particular, control of the procedure is effected by means of the control device 20, which sends preset control signals. Regulation of the supply is not necessary in the case of carrying out the method described.

According to the invention, there is provided a fuel cell system which is composed of at least subsystems which are independent at least in respect of their positionability, namely the fuel cell device module 26, the fuel supply device module 28, the oxidant supply device module 30 and the control device module 32.

The modules have defined interfaces for communication with other modules. The modules are separate. The respective functional components are fixedly disposed in them, so that a module may be put in place as a unit. Connecting elements and in particular lines and conduits connect the cooperating modules with one another.

The operating parameters and in particular flows of substances, electrical currents and signal currents may be separately set per module.

The modules may be produced separately.

An aspect relevant to safety is the fuel supply in the fuel cell system 10. By virtue of the modular manner of construction, the fuel cell system 10 is not dealt with as a whole, but only the modules in which the fuel is conducted, i.e. the fuel supply device module 28 (optionally also the fuel storage module 36) as well as the fuel cell device module 26 and the conduit 134. Within the fuel cell device module 26 and the fuel supply device module 28, the fuel may be conducted for example in bores which are formed by cut-outs in a solid material. By virtue of this, there is no necessity for tubes, which can spring a leak. Also the respective modules 26 and 28 may be formed to be gastight, while the entire fuel cell system 10 then no longer has to be formed to be gastight.

Furthermore, the modules 26 and 28 are provided with safety venting into the environment outside the entire system.

By virtue of the modularisation of the fuel cell system, it may be constructed in a versatile manner. In particular, adaptation to geometrical features is possible. Furthermore, each module may be individually optimised.

The lines and conduits between modules are independent of the modules. They may be connected to the modules by way of quick-release couplings, when conduits for the transport of substances are provided.

Easy repair or exchange of components of the fuel cell system 10 is also possible, since modules may be exchanged as a whole. For example, a fuel supply device module and/or a fuel storage module is exchanged as a whole.

Furthermore, there is also the result that the fuel cell system 10 can be easily dismantled and assembled.

In particular when metal hydride storage units 94 are used, the fuel storage unit or a fuel storage module can also form a structural element in an implementation using the system. In particular, a metal hydride storage unit of this kind can be used as a load-bearing structural element. The necessary fuel can then be carried along “on-board”. The oxidant required comes from the ambient air.

According to the invention, there is provided a simple fuel cell system 10 which is in particular air-cooled. Because of its modular construction, it may be integrated in a versatile manner into an implementation using the system. Operation does not need to be supervised.

1. Fuel cell system, comprising:
a fuel cell device having one or more fuel cell blocks in which chemical energy can be converted into electrical energy;
an oxidant supply device for the fuel cell device;
a fuel supply device for the fuel cell device; and
a control device;
wherein at least one of the fuel cell device and the oxidant supply device and the fuel supply device are formed as a module, the functional components of the respective device being disposed in the module, the respective module forming a unit which is positionable as a whole, and the respective module having a communication interface which has connectors.

2. Fuel cell system according to claim 1, wherein the respective module has a housing in which the functional components are located.

3. Fuel cell system according to claim 2, wherein the connector(s) are located on the housing.

4. Fuel cell system according to claim 2, wherein the housing is closed.

5. Fuel cell system according to claim 2, wherein the housing is gastight.

6. Fuel cell system according to claim 1, wherein the connectors comprise connectors for substances, signal connectors and electrical power connectors.

7. Fuel cell system according to claim 6, wherein the fuel cell device module has connectors for substances for oxidant and fuel and a connector for drawing off electrical power.

8. Fuel cell system according to claim 6, wherein the fuel cell device module has at least one signal connector for feeding in control signals.

9. Fuel cell system according to claim 6, wherein the fuel supply device module has at least one fuel connector for drawing off fuel.

10. Fuel cell system according to claim 6, wherein the fuel supply device module has at least one signal connector.

11. Fuel cell system according to claim 6, wherein the oxidant supply device module has at least one oxidant connector for drawing off oxidant.

12. Fuel cell system according to claim 6, wherein the oxidant supply device module has at least one signal connector.

13. Fuel cell system according to claim 1, wherein communicating modules are connected by way of at least one of lines and conduits.

14. Fuel cell system according to claim 13, wherein the lines and conduits are elements which are separate from the modules.

15. Fuel cell system according to claim 1, wherein one or more fuel storage units are integrated into the fuel supply module.

16. Fuel cell system according to claim 1, wherein at least one fuel storage unit is provided, which is coupled to the fuel supply device.

17. Fuel cell system according to claim 16, wherein one or more fuel storage modules are provided.

18. Fuel cell system according to claim 16, wherein the at least one fuel storage unit or the at least one fuel storage module is formed as a structural element of the fuel cell system or of an implementation using the system.

19. Fuel cell system according to claim 16, wherein the at least one fuel storage unit or the at least one fuel storage module is or comprises a metal hydride storage unit.

20. Fuel cell system according to claim 19, wherein the at least one fuel storage unit is formed by means of one or more extrusion profiles.

21. Fuel cell system according to claim 1, wherein a cooling device is associated with the fuel cell device.

22. Fuel cell system according to claim 21, wherein the cooling device is so located and formed that at least one fuel storage unit can be acted on by air conveying waste heat.

23. Fuel cell system according to claim 21, wherein the cooling device is formed as a module.

24. Fuel cell system according to claim 23, wherein the cooling device module has at least one connector for air conveying waste heat.

25. Fuel cell system according to claim 23, wherein the cooling device module has at least one signal connector.

26. Fuel cell system according to claim 1, wherein the control device is formed as a module.

27. Fuel cell system according to claim 1, wherein control of the procedure is provided by the control device, which sends preset control signals.

28. Fuel cell system according to claim 1, wherein electricity-consuming features of the fuel cell system are supplied with electrical energy by way of the control device.

29. Fuel cell system according to claim 1, wherein for each module, the operating parameters in respect of flows of substances, electric currents and signal currents are at least one of independently adjustable and set.

30. Fuel cell system according to claim 1, wherein, in at least one of the fuel supply device module and the oxidant supply module and the fuel cell device module, substance guidance is provided by means of a bore.

31. Fuel cell system according to claim 1, wherein the pressure and the volume flow of the air which is adapted to be drawn off as oxidant carrier is set to a constant value for the oxidant supply device.

32. Fuel cell system according to claim 1, wherein the pressure of fuel which is adapted to be drawn off is set to a constant value for the fuel supply device.

33. Fuel cell system according to claim 1, wherein the pressure difference for fuel which is adapted to be drawn off in relation to air which is adapted to be drawn off as oxidant carrier from the oxidant supply device is set to a constant value for the fuel supply device.

34. Fuel cell system according to claim 1, wherein regulation of the quantity of the fuel supplied to the fuel cell device is effected by the electrical power take-up by a consumer.

35. Fuel cell device for a fuel cell system, comprising:
one or more fuel cell blocks in which chemical energy can be converted into electrical energy;
said fuel cell device being formed as a module, the functional components of the fuel cell device being disposed in the module, the module forming a unit which is positionable as a whole, and the module having a communication interface with connectors.

36. Oxidant supply device for a fuel cell device of a fuel cell system,
said oxidant supply device being formed as a module, the functional components of the oxidant supply device being disposed in the module, the module forming a unit which is positionable as a whole, and the respective module having a communication interface with connectors.

37. Fuel supply device for a fuel cell device of a fuel cell system,
said fuel supply device being formed as a module, the functional components of the fuel supply device being disposed in the module, the module forming a unit which is positionable as a whole, and the module having a communication interface with connectors.
